(19) United States
(12) Patent Application Publication
(10) Pub. No.: US 2010/0146854 A1
(43) Pub. Date: Jun. 17, 2010

(54) APPARATUS FOR VERTICAL HORTICULTURE

(76) Inventors: Roy D. Cannon, Lakeland, FL (US); Sterling L. Cannon, Columbus, GA (US); Julian E. Cannon, Brandon, FL (US)

Correspondence Address: GRAY ROBINSON, P.A., P.O. Box 2328, FT. LAUDERDALE, FL, 33303-9998, US

(21) Appl. No.: 12/637,160

(22) Filed: Dec. 14, 2009

Related U.S. Application Data
(60) Provisional application No. 61/201,793, filed on Dec. 15, 2008.

(51) Int. Cl. A01G 9/02

(52) U.S. Cl. 47/82; 47/83

(57) ABSTRACT

In a preferred embodiment, a multi-level elevated stack of planting containers is mounted to vertical support pole. Each container has a plurality of planting compartments for containing a growing medium. The compartments are at least partially divided from one another by a vertically extending partition for at least partially limiting fluid transfer among the planting compartments within the same container. Each said planting compartments has a fluid drain through which any unabsorbed fluid drains into only a single respective one of the compartments of a container located at a lower of the stack. The drains in the compartments are radially offset from a through hole in each container which receives the support pole and fluid is discharged into radially offset locations of compartments at lower levels to deter fluid bypass between the pole and the through hole.

### CROSS-REFERENCE TO RELATED APPLICATIONS

This application claims priority under 35 U.S.C. §119(e) to U.S. Provisional Application Ser. No. 61/201,793 filed Dec. 15, 2008 for all commonly disclosed subject matter. U.S. Provisional Application Ser. No. 61/201,793 is expressly incorporated herein by reference in its entirety to form a part of the present disclosure.

### FIELD OF THE INVENTION

The invention relates to the field of horticulture. More particularly, the present invention relates to a horticultural apparatus for commercial and/or home use for growing of plants in a plurality of vertically stacked containers, each having a plurality of upwardly facing plant growing compartments, with plant nourishment and irrigation distributed to each plant growing compartment in the uppermost container of the stack from a reservoir located atop the stack, with unabsorbed fluid each planting growing compartment at each level of the stack draining downwardly to a respective individual plant growing compartment located at a lower level in the stack.

### BACKGROUND OF THE INVENTION

Because they make extended amounts of space above ground level, or floor level, available for plant production, vertically stacked plant growing systems are an effective way of increasing the plant yield per square area of ground or floor space available for growing plants. Such systems are also capable of providing lush vertical arrays of flowering or non-flowing plants which can be very attractive in appearance. When used for the production of vegetables or other crops, elevation of the plants also provides improved ergonomics for safe, fast and efficient harvesting. Various types of vertically stacked plant growing systems are known in the prior art, of which the following are but a few examples.

U.S. Pat. No. 4,419,843 to Johnson, Sr. discloses a self-irrigating, multi-tier vertical planter having a pan-shaped base within which is mounted an upstanding tubular post member. A plurality of trays, each having a radial V-shaped cross section for containing soil or other organic growing medium, are vertically stacked on one another and secured to the post member overlying the pan-shaped base. Each of the trays has a series of apertures at its lowest point to allow irrigating liquid to seep into the tray below. A second series of apertures is provided in the outer inclined wall to allow excess liquid to drip into a lower tray or into the base. A pipe mounted in the support tube carries irrigating liquid to a sprinkler manifold which is sprinkled down onto the trays below.

U.S. Pat. No. 6,612,073 to Powell et al. discloses an intensive plant growing stacking container system which includes a plurality of molded, stackable containers having multiple, mutually angularly spaced, lobes which can nest inside one another for efficient shipping and storage. Each container has a plurality of drain openings in its bottom and incorporates a number of support protrusions that fit into support openings on the top of the second container to provide vertical alignment and lateral stability when the containers are assembled in a stack for use each container includes a central opening through which may pass the pipe for providing both mechanical support and your geisha and liquid to the top of the stack. The lobes of the containers and support protrusions are arranged so that when the containers are assembled into a stack, the lobes of containers are alternatingly arranged. According to this arrangement, instead of all lobes in the stack being aligned vertically with one immediately atop another, the lobes of containers which lie immediately vertically adjacent to one another in the stack are angularly offset from one another. This provides room for plant growth with minimal interference or light blockage from lobes on the level of the stack lying immediately above.

U.S. Pat. No. 5,309,761 to Byun discloses stack type plant pots which are divided into radially extending pot portions by means of vertical partitions. The pot portions are generally shaped like a cone or funnel and have drain openings at their bottom. The pots can be stacked one upon another so that the pot portions form a vertically alternating arrangement similar to that described above in connection with Powell et al. '073. To provide for taller plants, or to alter the appearance of the stack, distance adjusting members which can be interposed between pots to adjust the vertical distance between the pots in the stack.

U.S. Pat. No. 6,840,008 to Bullock et al, discloses a vertical planting system having a plurality of growing containers formed of expanded polystyrene foam. Each container has an unpartitioned interior having a generally flat bottom which is provided with a plurality of drainage holes and a central support pole receiving aperture. Located at the corners each container are four planting areas each of which is in the general shape of a cone or funnel. The walls of the containers have alignment cavities and pins which enable the containers to be stacked on top of one another with the support pole running vertically upwardly up through the central apertures of the containers. The support pole terminates in a T-fitting which connects to a water supply. A water diffuser box is supported below the T-fitting on top of the top container of the stack and receives irrigation water from the water supply. The bottom of the diffuser box includes a plurality of drainage apertures which discharge water into the top of the top container in the stack. Whatever portion, if any, of that water is not absorbed by the growing media in the top container passes through the post receiving aperture and/or the drainage holes in the bottom of the top container and is discharged into the top of the container lying immediately below the top container. Unabsorbed water passes downwardly through the stack from one container to the next immediately lower container in the stack in the same manner until, after being discharged from the lowest container, any remaining fluid is received in a fluid collector.

The foregoing and other prior art vertical plant growing devices of which Applicant's are aware are subject to one or more of a number of problems. All are prone to uneven distribution of fluid (water and plant nutrients) to the individual containers in the stack. They are also prone to uneven distribution of fluids to each plant within a container. Prior art systems also do not provide visual verification of fluid delivery to plant growing compartments within the stack and/or do not provide visual verification of that fluids are distributed evenly among those plant growing compartments. Fluid distribution in prior art systems also is often unduly dependant on the wicking properties of the plant growing media used. In some prior art systems that use a vertical support rod where the rod is in intimate contact with the growing media, there is also a tendency for the rod to clear a fluid path of least fluid flow resistance through the container, thereby allowing fluid to bypass the growing media. Some prior art vertical plant growing devices, require fluid from higher containers to drip onto plants in the lower containers. Some fluids may be harmful when applied to leaves and blossoms. Also, plant foliage may deflect fluids out of the container intended to receive them, allowing them instead to be wasted, falling uselessly to the ground. Another problem common to many prior art vertical plant growing devices, particularly those made of synthetic plastic materials, such as expanded polystyrene foam for example, is that the upper edges of the containers are subject to degradation by ultraviolet (UV) rays and damage during normal use.

### SUMMARY OF THE INVENTION

In view of the foregoing, it is an object and advantage of the present invention to provide an apparatus for growing plants in a plurality of vertically spaced containers which provides even distribution of fluid, such as water either with or without dissolved or undissolved plant nutrients, to each growing compartment of the uppermost plant growing container. The present invention provides a structure which operates such that fluid not absorbed within an upper planting compartment is positively delivered only to a single lower compartment, assuring that if fluid is evenly applied at the uppermost compartments, it is evenly distributed to each lower plant growing compartment in the stack. A further aspect of the invention assures delivery of fluids to the outer regions of each plant growing compartment in a manner such that the even delivery of fluid is not reliant upon the wicking properties of the plant growing media. According to a further aspect of the invention, visual verification of even delivery of fluids to each plant growing compartment is provided. The invention allows for readily quantitatively measuring actual fluid delivery to any single plant growing container in the stack if desired. According to a further aspect of the invention, distribution of fluids is carried out by way of base plate which, in addition to aiding uniform and visually verifiable distribution of fluid, also provides protection of the upper edges of each plant growing container against UV degradation and mechanical damage. In the present invention, the fluid path down through the stack is preferably located away from the central support pole so that fluid will not tend to bypass the growth medium in the container by flowing along any bypass fluid path which might exist between the support pole and the growth medium in the container. The present invention prevents plants from being deprived of adequate fluid as can occur in prior art devices as a result of the opening of such a bypass fluid path. The invention also can be readily adapted into various shapes and sizes of components which may be retrofitted to improve existing installations of prior art vertical planting systems. Certain embodiments of the present invention provide positive separation of the roots of different plants within a container.

A preferred embodiment of the present invention includes a plant growing container with or partially-partitioned plant growing compartments, each compartment fitted with a directionally adjustable or non-adjustable fluid drain tube located at the bottom of each compartment which directs fluid (water and/or plant nutrients) into a single compartment of the next lower container. Each tube provides means for directing fluid flow outward and away from the central area of the next lower container to the desired area of the receiving compartment. Tubes are preferably transparent, but are not required to be, to enhance visual verification of fluid delivery to the intended receiving compartment. Fluid flow from each compartment of the lowest container in the stack provides redundant visual verification that fluid has been positively delivered to every plant growing compartment in the stack. Directionally adjustable or non-adjustable drain tubes may be retrofitted to prior art containers.

Three dimensional surface features are preferably molded onto the bottoms of the plant growing containers to mate with the container walls, partitions, or other features of the next lower container in the stack to assure desired axial and rotational alignment of the containers.

Preferred embodiments of the present invention include a fluid distribution system for low pressure delivery and distribution of fluid to each of the plant growing compartments of the uppermost plant growing container in the stack. This fluid distribution system may comprise a base plate which fits atop the uppermost plant growing container. The base plate is shaped to overlay the central area of the container and to overlay a portion of or all of the upper peripheral edges of the plant growing compartment walls. Features on the underside of the base plate are designed to engage the compartment walls, partitions, or other features of the plant growing container on which it rests. The base plate has a through-hole on its central axis. Passing concentrically through this through-hole is a cylindrical tube sealed at its intersection with the base plate. The inside diameter of this tube provides clearance for a stack support pole to pass through. Mounted atop the base plate, concentric with the cylindrical tube is a larger diameter tube, sealed at its base. The volume between the two concentric cylinders comprises a fluid reservoir atop the base plate. Located near the bottom of the outer cylindrical tube and passing through its wall are drain tubes, one tube discharging into each of the plant growing compartments of the plant growing container on which the base plate rests. The top area of the reservoir may be open or it may be topped by a cover rotationally fixed to the support pole but not to the reservoir. A fluid supply tube connected to an overhead fluid supply mainline discharges fluid into the reservoir, through the cap, if one is present. The fluid supply tube may include a fluid flow regulator. The fluid drain tubes, fluid supply line, and fluid flow regulator are sized such that fluid is delivered to the reservoir at a faster rate that it is being discharged through the reservoir drain tubes.

Embodiments of the present invention preferably include a support pole which passes axially through the stacked growing containers and the fluid distribution system. In addition to serving as an axial support for the stacked plant growing containers and support for the fluid distribution system, it also acts as a support for an overhead fluid supply mainline. The support pole is driven into the earth to a depth which establishes the desired elevation of the fluid delivery mainline. A support tube, larger in inside diameter than the support pole is placed onto the support pole and is driven into the earth to a depth which establishes the desired elevation of the stacked plant growing containers. A thrust washer is placed onto the support pole and rests upon the upper end of the support tube. The growing containers, when stacked onto the support pole, are vertically supported by this thrust washer. The stack of plant growing containers and the fluid distribution system atop the uppermost container all may be freely rotated as a unit about the support pole.

A second preferred embodiment of the plant growing container of the present invention includes fully-partitioned or partially-partitioned plant growing compartments with each compartment provided with fluid drain holes at the bottom of each compartment. The partitions are rotationally oriented to assure that fluid drains into a single compartment of the next lower container. The partitions may be molded as an integral part of the container or may comprise a fitted insert that provides equivalent compartment partitioning and sealing. Fluid flow from each compartment of the lowest container in the stack of containers provides visual verification of fluid flow to every plant growing compartment in the stack.

Features are molded onto the bottoms of the plant growing containers to mate with the walls, partitions, or other features of the next lower container to assure desired axial and rotational alignment of the containers.

A third preferred embodiment of the apparatus of the present invention includes fully- or partially-partitioned growing compartments, each compartment being provided with fluid drain holes at the bottom of the compartment feeding onto a partitioned fluid distribution tray fitted atop the next lower container. Each of the partitioned areas of the tray has a drain opening which allows fluid to discharge only into a single compartment of the underlying container. The partitioned fluid distribution tray directs fluid flow outward and away from the central area of the container to the desired area of the next lower container. The fluid distribution tray also can be adapted to overlie the upper portion of the peripheral wall of the container to provide protection against UV radiation and ordinary use damage to the upper edges of the container on which it rests. Raised features on the upper face of the fluid distribution tray provide support for the plant growing container placed upon it. These raised features also provide separation between the bottom of the plant growing container and the upper face of the tray. Features on the lower face of each fluid distribution tray mate with the upper peripheral edges, partitions, or other features of the underlying container and thus assure desired rotational and axial alignment of the containers with respect to each other. Fluid distribution trays may shaped and sized in a manner allowing them to be retrofitted into prior art plant growing containers to improve their fluid distribution characteristics and resistance to UV degradation and mechanical damage.

Features are molded onto the bottoms of the plant growing containers to mate with the walls, partitions, or other features of the next lower container to assure desired axial and rotational alignment of the containers.

A fourth preferred embodiment of the plant growing container of the present invention includes fully- or partially-partitioned growing compartments, each compartment provided with fluid drain holes at the bottom of the compartment. Surface features molded onto the bottoms of the plant growing containers mate with the walls, partitions, or other features of the next lower container to assure desired axial and rotational alignment of the containers. Each plant growing compartment within a container is also provided with a fluid directing trough, molded into or attached to the container's peripheral walls, which is configured to direct fluid flow from the drain holes in the bottom of the upper container into a single compartment of the next lower container. The fluid directing troughs direct the flow of fluid along a flow path which lying radially outwardly spaced away from the central area of the upper container to the desired area of the next lower receiving compartment.

These and other objects and advantages of the present invention, will be explained in further detail below with reference to the accompanying drawings in which like reference numerals are used to designate like items.

### BRIEF DESCRIPTION OF THE DRAWINGS

FIG. 1 is an upper perspective view illustrating a first preferred embodiment of a horticultural apparatus constructed according to the invention.

FIG. 2 is a close-up view of the upper portion of the embodiment of FIG. 1.

FIG. 3 is an upper perspective view of a plant growing container of the embodiment of FIG. 1.

FIG. 4 is a lower perspective view of a plant growing container of the embodiment of FIG. 1.

FIG. 5 is an upper perspective view illustrating a support system for use with containers according to the embodiments of FIGS. 1, 6, 9 and 13.

FIG. 6 is an upper perspective view of a plant growing container according to a second preferred embodiment of the invention.

FIG. 7 is a lower perspective view of the container of FIG. 6.

FIG. 8 is a top view illustrating two containers of the embodiment of FIG. 6 stacked on top of one another.

FIG. 9 is an upper perspective view of a plant growing container according to third preferred embodiment of the invention.

FIG. 10 is a lower perspective view of the container of FIG. 9.

FIG. 11 is an upper perspective view of a third preferred embodiment of a plant growing container with a fluid distribution tray, with the container shown stacked upon another fluid distribution tray.

FIG. 12 is a top view of the container and fluid distribution trays of FIG. 11.

FIG. 13 is an upper perspective view illustrating a plant growing container having fluid distribution troughs according to fourth preferred embodiment of the invention.

FIG. 14 is a lower perspective view of the container of FIG. 13.

FIG. 15 is a top view illustrating two containers, both having distribution troughs according to FIG. 13, stacked upon one another.

### DETAILED DESCRIPTION OF THE PREFERRED EMBODIMENTS

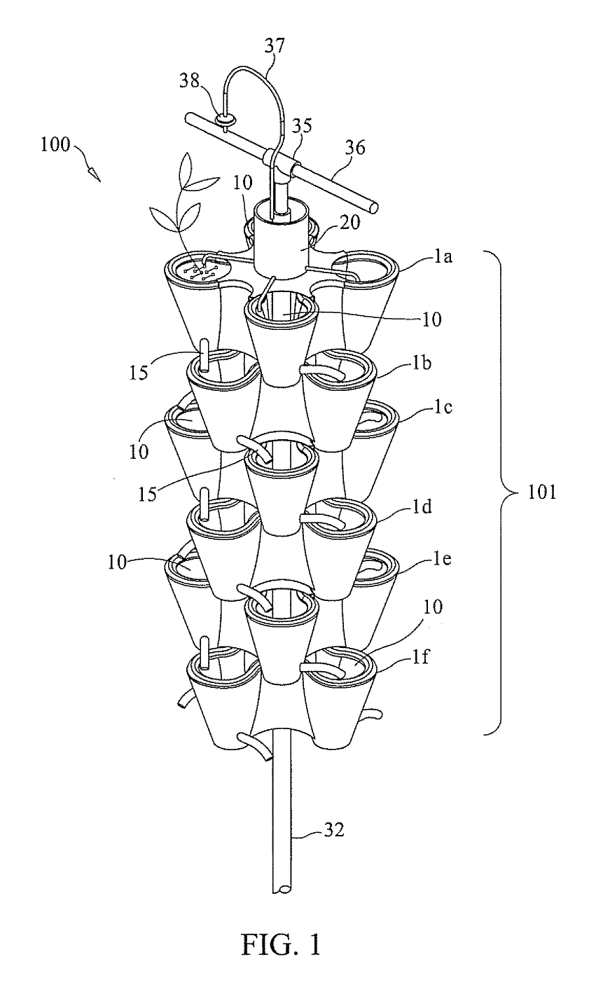

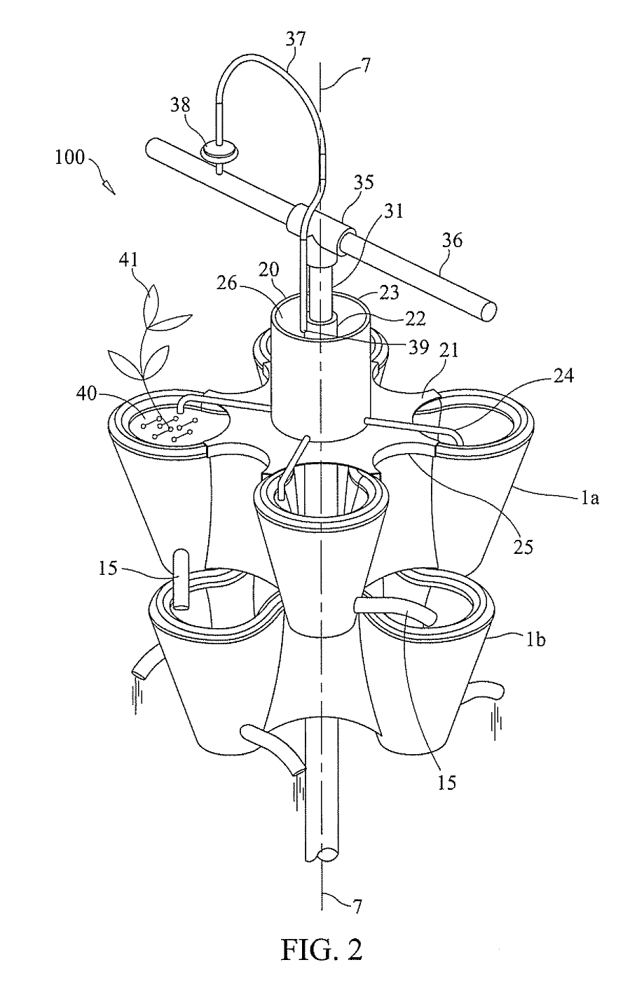

FIG. 1 is an upper perspective view illustrating a first preferred embodiment of a horticultural apparatus constructed according to the invention. Apparatus 100 includes multiple plant growing containers 1a-1f mounted atop one another to form a vertically extending stack 101. As FIG. 1 shows, stack 101 includes an uppermost container 1a, a lowest container 1f, and intermediate containers 1b, 1, 1d. Fitted atop the uppermost container 1a is a fluid distribution system 20. A vertical support pole 31 extends axially upward through the stacked growing containers 1a-1f and through the fluid distribution system 20. Mounted atop support pole 30 is a tee support 35. A fluid supply mainline 36 passes through tee support 35. A smaller fluid supply tube 37 is tapped into fluid supply mainline 36. Assembled in-line in the fluid supply tube 37 is a fluid flow regulator 38. FIG. 2 is a closer view of the upper portion of the preferred embodiment of the present invention.

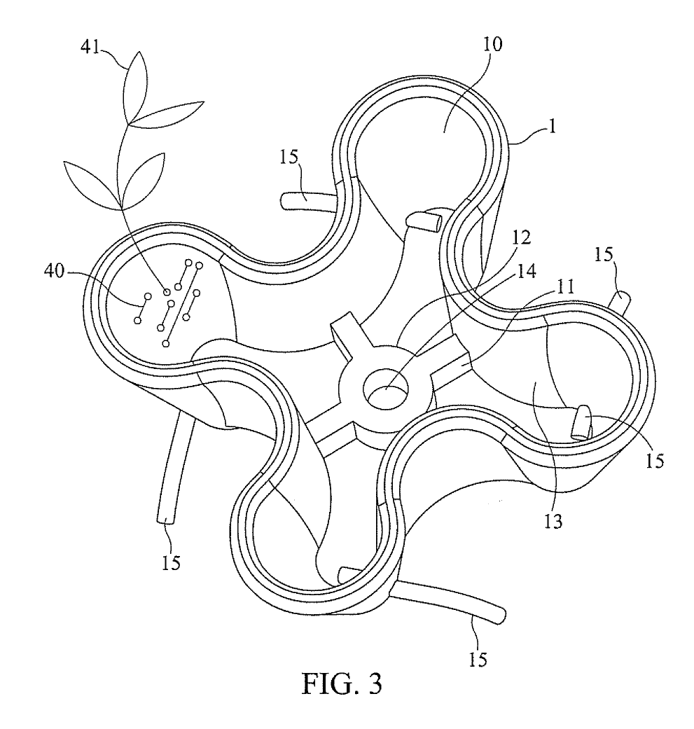

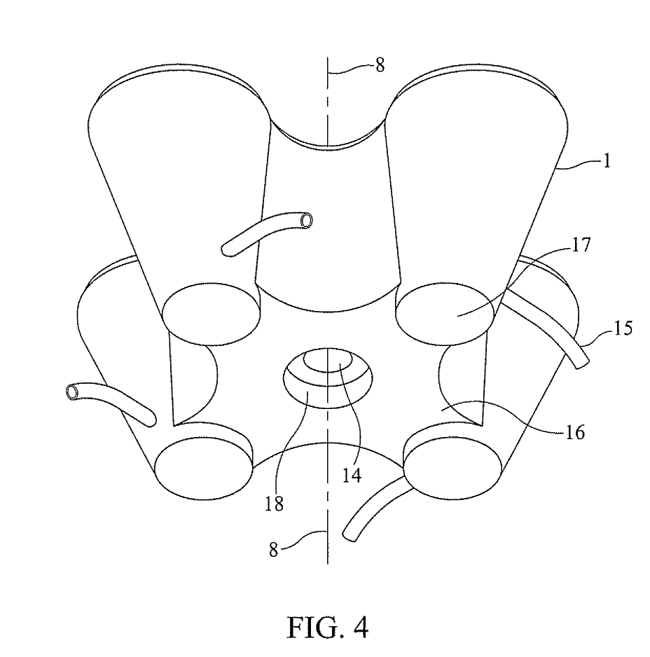

FIG. 3 is an upper perspective view of the preferred embodiment plant growing container 1 and FIG. 4 is a lower perspective view of the container 1. Plant growing container 1 comprises multiple plant growing compartments 10 into which a plant growing media 40 is placed. Plants 41 are planted into the plant growing media 40. Plant growing compartments 10 are formed within the plant growing container 1 by full or partial vertical partitions 11. Partial vertical partitions 11 which extend upwardly from the bottoms of compartments 10 to only a portion of the useful interior height of compartments 10 are shown in the container 1 of FIG. 3. The vertical partitions 11 are bounded by a central hub 12 and the walls 13 of plant growing container 1. Axially located within hub 12 is a through-hole 14. A compartment drain tube 15 passes through the walls 13 of each of the compartments 10. On the bottom surface 16 of the plant growing container 1 are alignment features 17 and a support surface 18.

Referring now to FIGS. 1 and 2, fitted atop the uppermost container 1a is a fluid distribution system 20, comprising a base plate 21, an inner cylindrical tube 22, an outer cylindrical tube 23, and drain tubes 24. Features 25 are provided on the bottom of base plate 21 to engage the upper peripheral walls 13 of the next lower plant growing container 1b. A fluid reservoir 26 is formed by inner cylindrical tube 22, outer cylindrical tube 23, and the base plate 21.

A vertical support pole 31 extends axially upward through the stacked growing containers 1a-1f and through the fluid distribution system 20. Mounted atop pole 31 is a tee support 35. A fluid supply mainline 36, typically carrying water or water with dissolved or undissolved nutrients, passes through tee support 35. A smaller fluid supply tube 37 is tapped into fluid supply mainline 36. Assembled in-line in the fluid supply tube 37 is a fluid flow regulator 38. The distal end 39 of fluid supply tube 37 is positioned to discharge into fluid reservoir 26.

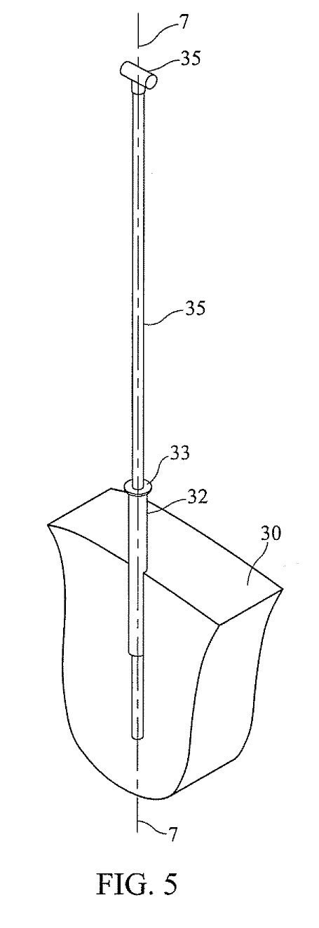

FIG. 5 is an upper perspective view further illustrating the support pole 31 of FIG. 1, showing support pole 31 driven into earth 30. Also shown driven into the earth 30 is a support tube 32. Mounted atop support tube 32 is a thrust washer 33, and atop the support pole 31 is support tee 35.

To assemble the embodiment of FIGS. 1 through 5, support pole 31 is driven into the earth to a depth which establishes the desired height for the support tee 35. Next, support tube 32 is driven into the earth coaxially with support pole 31 to establish the desired elevation of the lowest plant growing container 1f. Thrust washer 33 is placed atop support tube 32. Plant growing containers 1a-1f are stacked onto the support pole 31, atop thrust washer 33. The alignment features 17 of each of the containers 1a-1e are fitted into the curvatures of the walls 13 of the previously stacked containers 1b-1f to assure proper axial and rotational alignment. Fluid distribution system 20 is assembled onto the uppermost container 1a. Fluid supply mainline 36 is assembled through support tee 35. A fluid supply tube 37 and an in-line fluid flow restrictor 38 are tapped into fluid supply mainline 36. The distal end 39 of fluid supply tube 37 is positioned to discharge into the fluid reservoir 26.

In operation of a horticultural apparatus 100 constructed according to FIGS. 1-5, fluid, preferably a combination of water and liquid plant nutrients, is introduced under pressure into fluid supply mainline 36. Fluid flows into fluid supply tube 37, through fluid flow restrictor 38 and discharges into fluid reservoir 26. Fluid flow regulator 38 is sized such that fluid is introduced into fluid reservoir 26 at a higher flow rate than the combined flow rates of the multiple fluid drain tubes 24. The fluid level rises in fluid reservoir 26 until flow from the fluid supply mainline 36 ceases. The fluid remaining in reservoir 26 continues to drain equally from the multiple fluid drain tubes 24 until fluid reservoir 26 is emptied. Each of the fluid drain tubes 24 discharge fluid into the plant growing media 40 contained in a single plant compartment 10 of the uppermost plant growing container 1a. As the fluid passes down through the plant growing media 40, a portion of the fluid is absorbed by the media 40 and is thus made available to the plant 41 growing in the plant growing compartment 10. The portion of the fluid not absorbed by the media 40 flows to the bottom of the compartment 10 and begins to flow out of the compartment 10 via the compartment drain tube 15. The fluid flowing out of each compartment drain tube 15 discharges into the plant growing media 40 of a single plant compartment 10 of the next lower container 1b, and so on, until fluid not absorbed by media 41 in any of the plant containers 1a-1f above flows from the compartment drain tube 15 of the lowest plant growing container 1f.

As can be seen from FIGS. 1 and 2, the containers 1a-1f are positioned in a rotationally angularly alternating fashion in stack 101 such that the compartments of containers 1 of immediately adjoining levels of stack 101 are rotationally angularly offset from one another to provide better clearance for plants 41. As can also be seen from FIGS. 1 and 2, the compartment drain tube 15 of each compartment 10 is positioned to direct fluid into a single, rotationally angularly offset compartment 10 in the container 1 lying in an immediately lower, adjoining level of stack 101 to help avoid fluid drippage onto the foliage of plants 41. It can also be seen from FIGS. 1 and 2 that compartment drains 15 are positioned to discharge into a location in the upper portion of a lower compartment that lies radially offset from the central through hole 14 so as to reduce the tendency of fluid to establish a bypass route between the support pole 31 and the through hole 14. The discharge end of compartment drain tubes 15 are readily exteriorly visible in use to facilitate simple visual verification of fluid flow. Preferably, drain tubes 15 are also transparent.

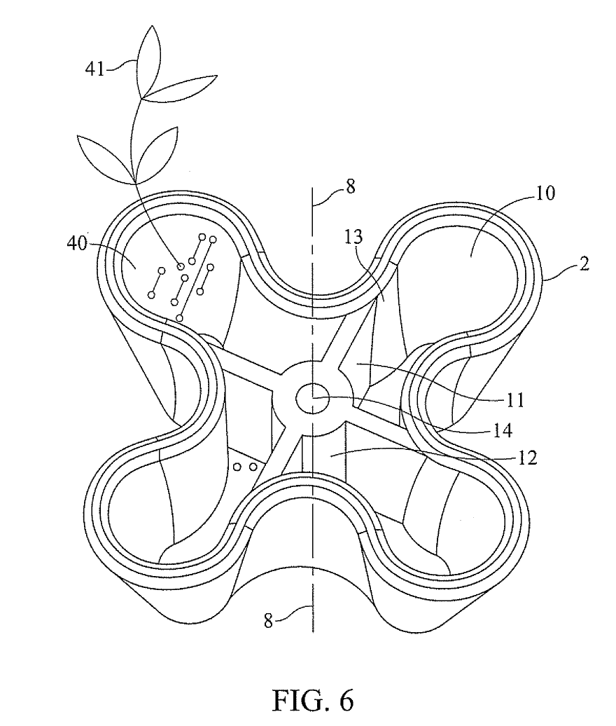

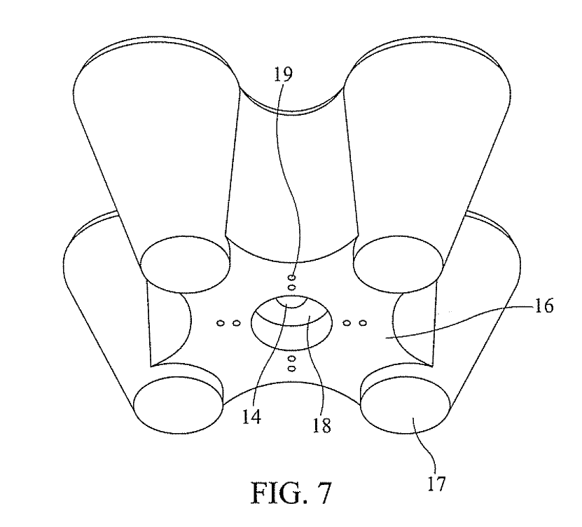

FIG. 6 is an upper perspective view of a container 2 constructed according to a second preferred embodiment of the present invention and FIG. 7 is a lower perspective view thereof. Plant growing container 2 comprises multiple plant growing compartments 10 into which a suitable amount of growing medium 40 is placed. Planted in growing media 40 are plants 41. The plant growing compartments 10 are formed within plant growing container 2 by full or partial vertical partitions 11. Full vertical partitions are shown in the container 2 of FIG. 6. The vertical partitions 11 are bounded by a central hub 12 and the walls 13 of plant growing container 2. Axially located within hub 12 is a through-hole 14. Passing through the bottom surface 16 are compartment drain holes 19. On the bottom surface 16 of the plant growing container 2 are alignment features 17 and a support surface 18. The central hub 12 helps prevent formation of a bypass fluid flow path between the growing medium 40 and the support pole 31. FIG. 8 is a top view of a first plant growing container 2, designated as 2a, stacked atop a second identical plant growing container 2, designated as container 2b in FIG. 8.

In operation of a horticultural apparatus 100 constructed using containers of the type illustrated in FIGS. 6-8, fluid is delivered to each of the plant growing compartments 10 of the uppermost plant growing container 2a by the fluid distribution system 20, previously described. As the fluid passes down through the plant growing media 40 present in the compartment 10, a portion of the fluid is absorbed by the media 40 and is thus made available to the plant 41 growing in compartment 10. The portion of the fluid not absorbed by the media 40 flows to the bottom of the compartment 2 and begins to flow out of compartment 2 via the compartment drain holes 19. Because of the rotational orientation of the partitions 11 within container 2a, the fluid flowing out of each the compartment drain holes 12 discharges only into the plant growing media 40 of a single plant compartment 10 of the next lower container 2b in stack 101, and so on, until fluid not absorbed by media 40 in any plant container 2 in the stack flows from the compartment drain holes 19 of the lowest plant growing container 2.

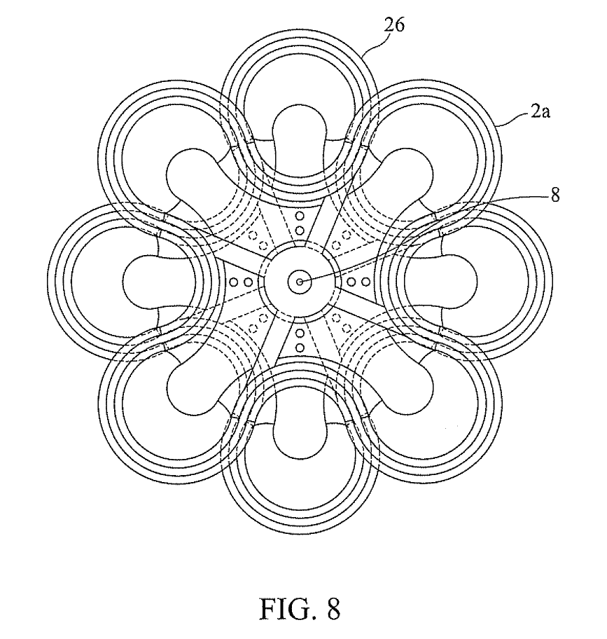

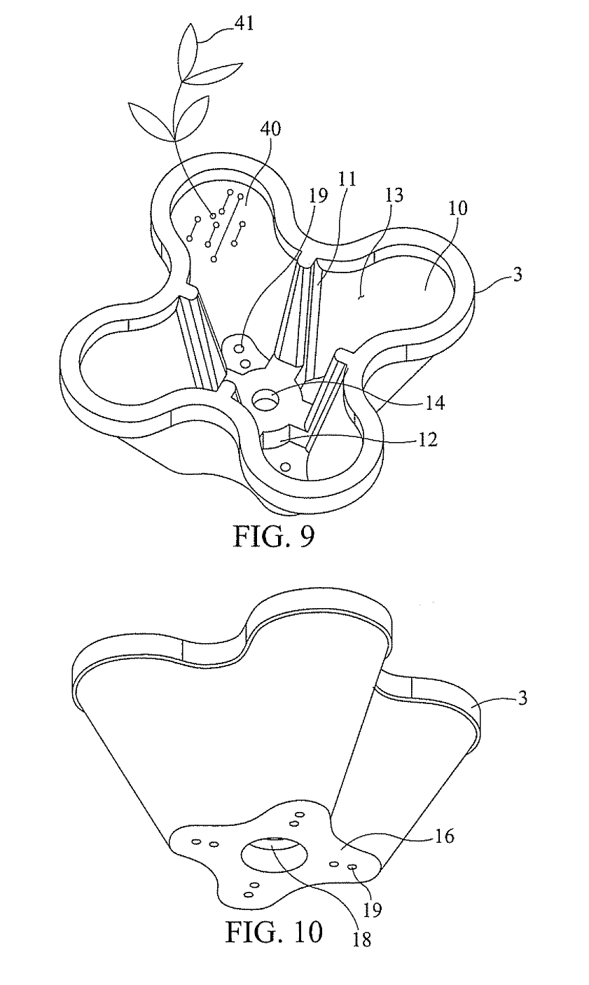

FIG. 9 is an upper perspective view of a container 3 constructed according to a third preferred embodiment of the invention and FIG. 10 is a lower perspective view thereof. Plant growing container 3 comprises multiple plant growing compartments 10 into which a suitable quantity growing medium 40 is placed. Planted in growing media 40 are plants 41. The plant growing compartments 10 are formed within the plant growing container 3 by full or partial vertical partitions 11. The full or partial vertical partitions 11 are bounded by a central hub 12 and the walls 13 of plant growing container 3. Axially located within hub 12 is a through-hole 14. Passing through the bottom surface 16 are compartment drain holes 19. On the bottom surface 16 of the plant growing container 3 is a support surface 18.

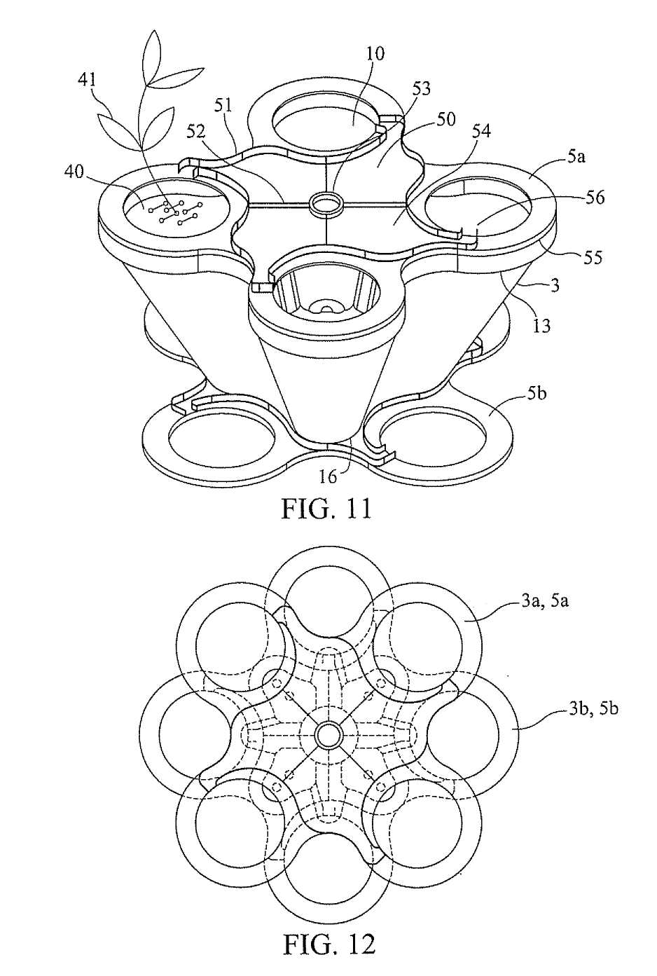

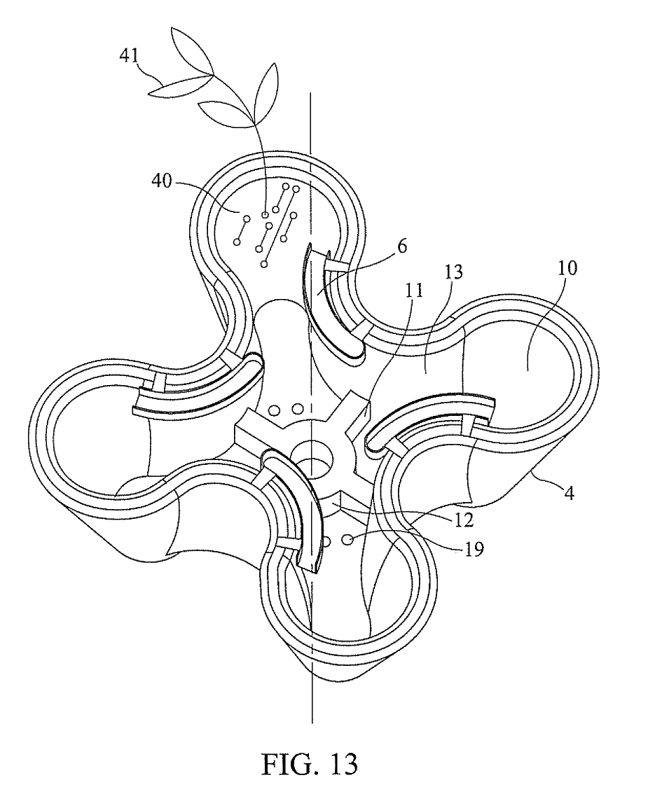

FIG. 11 is an upper perspective view of illustrating a plant growing container 3 shown stacked upon a fluid distribution tray 5b. Another fluid distribution tray 5a rests upon the top of plant growing container 3a. FIG. 12 is a top of a plant growing container 3a fitted with a first fluid distribution tray 5a, shown stacked on top of a second plant growing container 3b which is fitted with a second fluid distribution tray 5b.

Each fluid distribution tray 5a, 5b comprises a base plate 50, upper peripheral walls 51, partitioning dividers 52 and an axial hub 53. Partitioned areas 54 are formed by the upper peripheral walls 51, partitioning dividers 52, and an open axial hub 53. Lower peripheral walls 55 are attached to the bottom of base plate 50. Base plate 50 is shaped to fit the upper peripheral walls 13 of plant growing container 3. The lower peripheral walls 55 engage the peripheral walls 13 at the top of plant growing container 3. The upper peripheral walls 51 are shaped to fit the shape of the bottom surface 16 of plant growing container 3. Each of the upper peripheral walls 51 has an fluid outlet 56 which allows fluid to discharge into a single plant growing compartment 10 of the plant growing container 3 on which it sits.

In operation of a horticultural apparatus 100 constructed using containers 5 of the type illustrated in FIGS. 11 and 12, fluid is delivered to each of the partitioned areas 54 of fluid distribution tray 5a by the fluid distribution system 20, previously described. Fluid from each of the partitioned areas 54 discharges from a fluid outlet 56 into the plant growing media 40 of a single plant growing compartment 10 of the container 3a on which the fluid distribution tray 5a sits. As the fluid passes down through the plant growing media 40, a portion of the fluid is absorbed by the media 40 and is thus made available to the plant 41 growing in the compartment 10. The portion of the fluid not absorbed by the media 40 flows to the bottom of the plant growing compartment 10 and begins to flow out of the compartment 10 via the compartment drain holes 19. The fluid flowing out of each compartment drain hole 19 is delivered to a single partitioned area 54 of fluid distribution tray 5b on which the plant growing container 3a sits, and so on, until fluid not absorbed by media 40 in any plant container 3 in the stack flows from the compartment drain holes 19 of the lowest plant growing container 3.

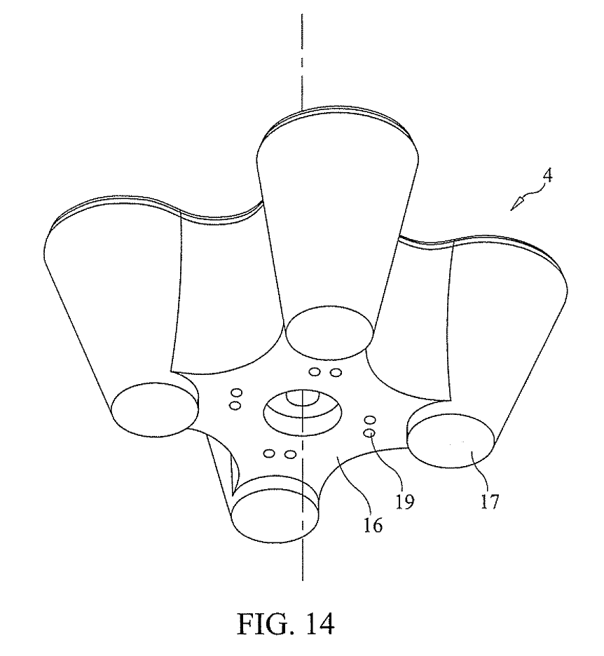

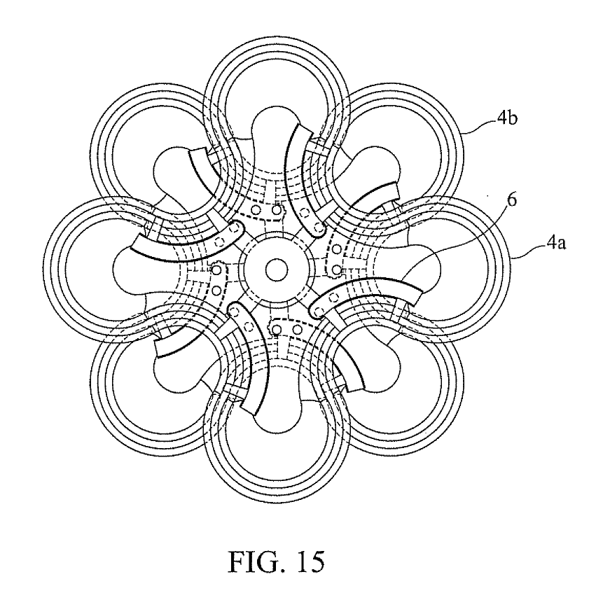

FIG. 13 is an upper perspective view of a plant growing container 4 constructed according to a fourth preferred embodiment of the invention and FIG. 14 is a lower perspective view thereof. Plant growing container 4 comprises multiple plant growing compartments 10 into which a quantity of a suitable growing medium 40 is placed. Planted in growing medium 40 are plants 41. The plant growing compartments 10 are formed within plant growing container 4 by full or partial vertical partitions 11. The full or partial vertical partitions 11 are bounded by a central hub 12 and the walls 13 of plant growing container 4. Axially located within hub 12 is a through-hole 14. Passing through the bottom surface 16 are compartment drain holes 19. On the bottom surface 16 of plant growing container 4 are alignment features 17. Fluid directing troughs 6, molded into or attached to the top of the peripheral walls 13 of plant growing container 4, direct fluid flow from the drain holes 19 in the bottom 16 of an upper container 4a into a single compartment 10 of a next lower container 4b. The fluid directing troughs 6 provide means for directing fluid flow outward and away from the central area of the upper container 4a to the desired area of the next lower receiving container 4b. FIG. 15 is a top view of a first plant growing container 4, that first container 4 being designated in FIG. 15 as container 4a, stacked atop a second plant growing container 4, the second container 4 being designated in FIG. 15 as 4b.

In operation, of a horticultural apparatus 100 constructed using containers 4 of the type illustrated in FIGS. 13 through 15, fluid is delivered to each of the plant growing compartments 10 of the uppermost plant growing container 4a by the fluid distribution system 20, previously described. As the fluid passes down through the plant growing media 40, a portion of the fluid is absorbed by the media 40 and is thus made available to the plant 41 growing in the compartment 10. The portion of the fluid not absorbed by the media 40 flows to the bottom of the compartment 10 and begins to flow out of the compartment 10 via the compartment drain holes 19. The fluid flowing out of each compartment drain hole 19 discharges only into a single fluid directing trough 6. The discharge from each fluid directing trough 6 directs fluid flow outward and away from the central area of the upper container 4a to the desired area of the next lower receiving container 4b and so on, until fluid not absorbed by media 40 in any plant container 4 in the stack flows from the compartment drain holes 19 of the lowest plant growing container 4 in the stack.

While the invention has been described with reference to the preferred embodiments, it should be understood by those skilled in the art that various changes may be made and equivalents substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A horticultural apparatus, comprising:
a support pole mountable along a vertical axis;
a plurality of planting containers mounted to said support pole to form an elevated stack of said containers, said stack having multiple levels of said containers, said stack including at least an uppermost container, a lowest container, and at least one intermediate container, each said container having a plurality of planting compartments for containing a growing medium, each said container also having at least one vertically extending partition located between adjacent ones of said planting compartments within said container for at least partially limiting fluid transfer from said growing medium in one of said planting compartments to said growing medium in another one of said planting compartments of the same said container, each said planting compartments having at least one fluid drain located in a lower portion thereof, each said fluid drain of each one of said planting compartments of said uppermost container and each of said intermediate containers being drainable by way of said at least one fluid drain into only a single respective one of said compartments of a said container located at a lower one of said levels of said stack.

2. The apparatus of claim 1 further comprising a fluid reservoir in fluid communication with each of said planting compartments of said uppermost container for delivering fluid from said reservoir into each respective one of said planting compartments of said uppermost container.

3. The apparatus of claim 2 wherein said fluid communication is provided by way of a fluid path which includes a plurality of drain tubes, each of which discharges said fluid into a respective one of said planting compartments of said uppermost container.

4. The apparatus of claim 2 wherein said reservoir comprises an annular chamber having an outer wall and a tubular inner wall, said tubular inner wall having a central opening which receives said support pole to mount said reservoir to said support pole.

5. The apparatus of claim 4 wherein said reservoir further comprises a base plate which adjoins said outer wall of said reservoir, said base plate having engagement features for mounting said base plate to said uppermost container.

6. The apparatus of claim 5 wherein said drain tubes are attached to said base plate and said engagement features of said base plate engage a complementary shaped portion of said uppermost container to rotationally angularly orient said drain tubes to discharge into said compartments of said uppermost container.

7. The apparatus of claim 2 wherein said partition comprises a full partition which prevents said fluid transfer between said growing medium in said one of said planting compartments to said growing medium in said another one of said planting compartments.

8. The apparatus of claim 2 wherein said partition comprises a partial portion which partially limits but does not prevent said fluid transfer between said growing medium in said one of said planting compartments to said growing medium in said another one of said planting compartments.

9. The apparatus of claim 1 further comprising at least one fluid distribution tray mounted to said support pole interposed between at least a first one and a second one of said containers of said stack, said distribution tray having a base plate which includes a plurality of partitioned areas, each of said partitioned areas having a respective fluid outlet, each one of said partitioned areas being positioned to receive fluid draining from said at least one fluid drain of a respective one of said planting compartments of said first one of said containers and to discharge said fluid into a respective one of said planting compartments of said second one of said containers.

10. The apparatus of claim 9 wherein said plant growing containers have peripheral walls and wherein said base plate of said fluid distribution tray supportably rests upon said second one of said containers and covers an upper portion of said peripheral wall of said second one of said containers.

11. The apparatus of claim 1 wherein said fluid drain comprises an exteriorly visible outlet.

12. The apparatus of claim 11 wherein said drain tube is directionally adjustable for directing said fluid into a selectable single one of said compartments of a said container located at a lower one of said levels of said stack.

13. The apparatus of claim 11 wherein said drain tube is transparent.

14. The apparatus of claim 1 further comprising at least one fluid directing trough disposed to receive said fluid from a said at least one fluid drain of one of said planting compartments and to discharge said fluid into said only single respective one of said compartments of a said container located at said lower one of said levels in said stack.

15. The apparatus of claim 1 wherein said planting containers each include a through hole which receives said support pole to mount said container to said support post and wherein said fluid drain of each of said planting compartments lie radially offset from said axis and wherein said fluid draining from said at least one fluid drain drains into said respective one of said compartments at a location radially offset from said axis, to deter bypass fluid flow between said support post and said through hole is avoided.

16. The apparatus of claim 15 further comprising a hub surrounding said through hole and extending vertically upwardly through at least a portion of said compartment.
